(19) United States
(12) Patent Application Publication
(10) Pub. No.: US 2008/0191405 A1
(43) Pub. Date: Aug. 14, 2008

(54) Sheet-Processing Machine Having a Device for Generating Pneumatic Forces

(75) Inventor: Jens Forche, Freinsheim (DE)

Correspondence Address: LERNER GREENBERG STEMER LLP, P O BOX 2480, HOLLYWOOD, FL, 33022-2480, US

(73) Assignee: HEIDELBERGER DRUCKMASCHINEN AG, Heidelberg (DE)

(21) Appl. No.: 12/018,543

(22) Filed: Jan. 23, 2008

(30) Foreign Application Priority Data
Feb. 12, 2007 (DE) 10 2007 006 749.8

(51) Int. Cl. B65H 5/22; B41F 13/02

(52) U.S. Cl. 271/15; 271/10.02; 270/1.01

(57) ABSTRACT

A sheet-processing machine, such as a printing press, includes a device for generating pneumatic forces, such as pressure or negative pressure, at consumers. A pneumatic pressure generator is disposed directly at the consumer to minimize lag times between the generator and the consumer.

### CROSS-REFERENCE TO RELATED APPLICATION

This application claims the priority, under 35 U.S.C. § 119, of German Patent Application DE 10 2007 006 749.8, filed Feb. 12, 2007; the prior application is herewith incorporated by reference in its entirety.

### BACKGROUND OF THE INVENTION

### Field of the Invention

In sheet-processing machines, particularly printing presses, a sheet to be processed is aligned in a sheet travel direction and in a lateral direction before the sheet is processed, for example printed on.

Drive rollers and drive belts serve for transporting the sheet against so-called front lays or guides, against which the sheet is aligned in the direction of sheet travel. So-called pulling or drawing devices move the sheet against lateral stops. In most cases, those alignment devices operate mostly with pneumatic cohesive or retaining forces that temporarily fix the sheet to the alignment devices. Vacuum generators are generally introduced for producing the pneumatic forces, and the cycle of the vacuum generators is controlled by rotary valves.

German Published, Non-Prosecuted Patent Application DE 35 21 691 A1 discloses a so-called pull rail or pulling bar, which sucks up or attracts a sheet by pneumatic forces, such as a vacuum, for example, and aligns the sheet against a lateral stop. A control unit, in the form of a rotary valve, for example, is provided for cyclically controlling the device. The control unit controls suction air generated by a vacuum source in accordance with the cycle of the sheet-processing machine.

A connecting element connects the suction pull rail to the control unit, which is disposed in a decentralized manner.

Due to the inertia of the suction air, delays occur between the ready-making or provision of the suction air by the control unit, and the arrival of the suction air at the consumer, for example the suction pull rail or pulling bar.

Such delays can be partly compensated for by appropriate advance actuations.

### BRIEF SUMMARY OF THE INVENTION

It is accordingly an object of the invention to provide a sheet-processing machine having a device for generating pneumatic forces, which overcomes the hereinafore-mentioned disadvantages of the heretofore-known devices of this general type and which can be disposed at a central location on the consumer.

With the foregoing and other objects in view, there is provided, in accordance with the invention, a sheet-processing machine, comprising a consumer and a device for generating pneumatic pressure and/or suction pulses for said consumer. The device includes a pneumatic pressure generator having a variable-volume operating space. The consumer is disposed directly at said variable-volume operating space of said pneumatic pressure generator.

In accordance with another feature of the invention, the generating device includes a movable boundary wall of the operating space.

In accordance with a further feature of the invention, the boundary wall is a membrane.

In accordance with an added feature of the invention, the generating device includes an actuator for displacing the membrane.

In accordance with an additional feature of the device, the actuator is a moving-coil actuator.

In accordance with yet another feature of the invention, the actuator is controllable by a control unit of the sheet-processing machine in accordance with the processing cycle of the machine, following one of a characteristic line and a closed-loop control circuit.

In accordance with yet a further feature of the invention, the consumer is a pulling bar in the alignment region of a sheet feeder.

In accordance with yet an added feature of the invention, the consumer is a groove disposed transversely to the direction of sheet travel in the alignment region of a sheet feeder.

In accordance with yet an additional feature of the invention, the consumer is an advancing member disposed in the alignment region of a sheet feeder.

In accordance with a concomitant feature of the invention, the sheet-processing machine is a rotary printing press.

There is thus provided, in accordance with the invention, a pneumatic pressure generator, which may be a compressed-air generator or suction-air generator, depending upon the consumer, that can be disposed directly on the consumer. Due to this measure, no advance actuations of the generator are required to be made or set as a function of the processing speed of the machine.

A pressure or suction pulse can be generated within a very short period of time. Placing the pneumatic pressure generator directly on the consumer improves the response or reaction time of the air. The invention permits both pressure and suction pulses to be combinable in one device in a very simple manner, independently of a drive. It is also possible, however, to generate short pressure or suction pulses. By selecting suitable actuators, the invention offers an additional possibility of attaining optimum operating pressure at all times by avoiding undesirable lag times as may occur, for example, if the air is controlled by decentralized rotary valves. In this regard, the pressure magnitude as well as the instants or points of time may possibly be varied. It is further possible to control this unit through a performance graph or a control loop.

In an advantageous embodiment, there is provided a room or space having a variable volume, which is delimited by, amongst others, a movable diaphragm or membrane. The diaphragm or membrane is movable by a rapid-reacting or quick-action actuator such as a plunger-type actuator, for example, which is activatable in accordance with the cycle of the sheet-processing machine.

A particularly advantageous application of the device according to the invention is the configuration of the pneumatic pressure generator on a pulling bar in the alignment region of a feeder of a sheet-processing machine.

A further advantageous application is the configuration of the pneumatic pressure generator on a suction groove extending perpendicularly to the direction of sheet travel for cyclically smoothing the aligned sheets.

A third advantageous application is to place the pneumatic pressure generator on a drive roller or advancing roller for transporting the sheets.

Other features which are considered as characteristic for the invention are set forth in the appended claims.

Although the invention is illustrated and described herein as embodied in a sheet-processing machine having a device for generating pneumatic forces, it is nevertheless not intended to be limited to the details shown, since various modifications and structural changes may be made therein without departing from the spirit of the invention and within the scope and range of equivalents of the claims.

The construction and method of operation of the invention, however, together with additional objects and advantages thereof will be best understood from the following description of specific embodiments when read in connection with the accompanying drawings.

### BRIEF DESCRIPTION OF THE SEVERAL VIEWS OF THE DRAWING

FIG. 1 is a diagrammatic, side-elevational view of a sheet-fed rotary printing press;

FIG. 2 is a greatly enlarged, fragmentary, top-plan view of FIG. 1 showing an alignment region in a feeder thereof;

FIG. 3 is an enlarged, fragmentary, cross-sectional view of FIG. 2 showing a pull-rail or pulling bar having a pneumatic pressure generator in accordance with the invention;

FIG. 4 is a view similar to FIG. 3 showing the pneumatic pressure generator on a suction groove; and

FIG. 5 is a view, reduced in size and rotated through 90 degrees, of the pneumatic pressure generator of FIG. 3, on a sheet drive roller.

### DETAILED DESCRIPTION OF THE INVENTION

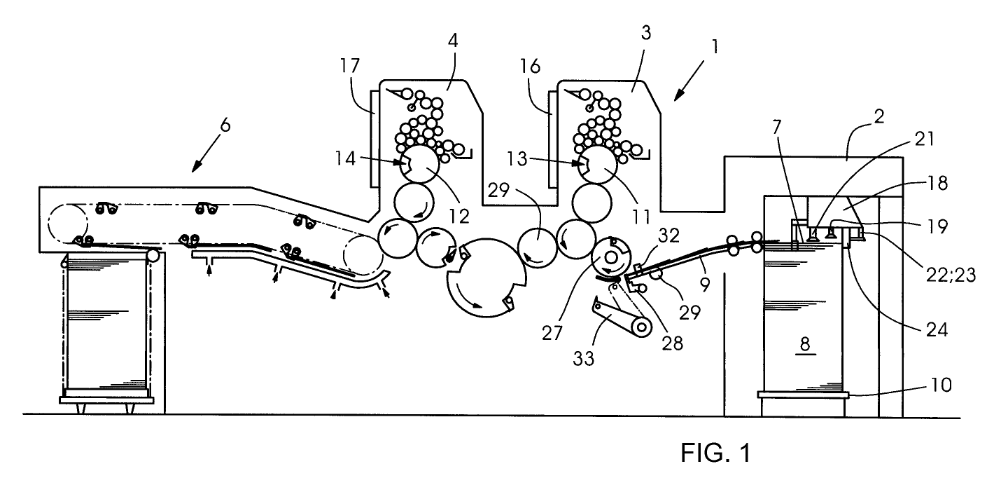

Referring now to the figures of the drawings in detail and first, particularly, to FIG. 1 thereof, there is seen a sheet-processing machine, for example a printing press 1, having a feeder 2, at least one printing unit 3 and 4 and a delivery 6. Sheets 7 are taken from a sheet stack or pile 8 and are fed to the printing units 3 and 4 individually or in shingled formation over a feed table 9. Each of the printing units 3 and 4 includes a respective plate cylinder 11, 12 as is generally known in the art. Each of the plate cylinders 11 and 12 has a respective device 13, 14 for mounting flexible printing plates on the plate cylinders 11, 12. In addition, a respective device 16, 17 for effecting semi-automatic or fully automatic plate changes is associated with each plate cylinder 11, 12.

The stack or pile 8 of the sheets 7 rests on a stack or pile plate 10 that is liftable in a controlled manner. The sheets 7 are removable from the top of the stack 8 by a so-called suction head 18, which includes, among other elements, a number of lifting and dragging suction elements 19, 21 for separating or singling the sheets 7. In addition, blower devices 22 for loosening the upper sheet layers, and sensing elements 23 for resetting or readjusting the stack 8, are provided. A number of lateral and rear stops 24 are provided to align the stack 8, particularly the topmost sheet 7 in the stack 8.

The sheet 7 is aligned before the sheet 7 is transferred to a first cylinder, such as a feed cylinder 27 of the sheet-processing machine. The alignment in the direction of sheet travel is carried out, for example, against front lays or guides 28 by conveying the sheet against the front lays or guides 28, for example by an advancing member such as a pneumatically operable advancing or drive roller 29.

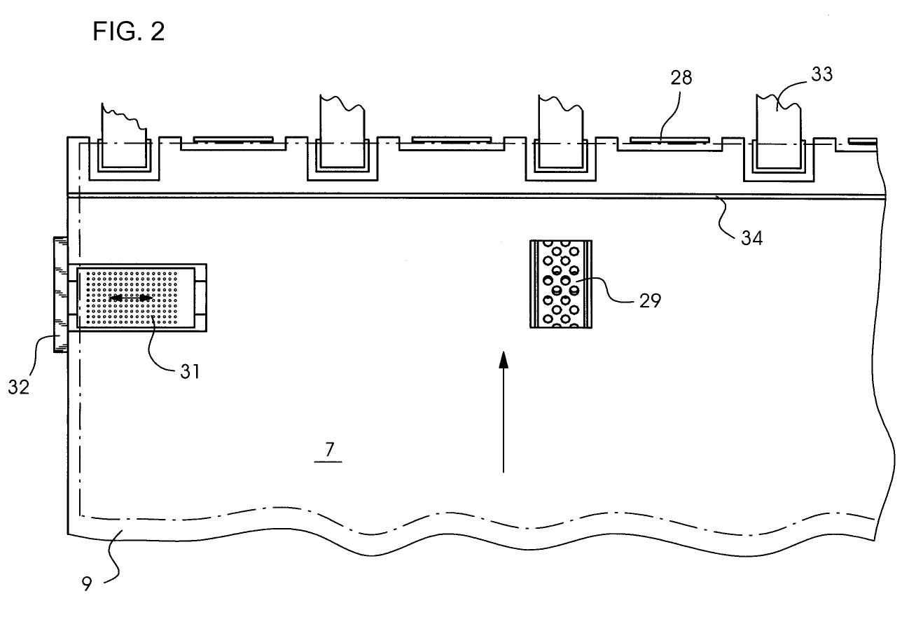

Lateral alignment of the sheet 7 in a direction transversely to the sheet travel direction is performed by a pneumatically-operated pulling device, such as a pull bar 31, for example, which is movable transversely to the direction of sheet travel and conveys the respective sheet to be aligned against a lateral pulling stop 32. See FIG. 2.

Before the aligned sheet 7 is grasped by further transporting members, such as pre-grippers 33 of the sheet-processing machine, for example, the sheet 7 is fixed on the feed table 9 by a pneumatically actuatable groove or slot 34, which extends transversely to the sheet travel direction.

The pneumatic actuation of the advancing roller 29, the pulling bar 31, and the groove 34 respectively occur in accordance with the cycle of the sheet-processing machine, preferably for generating retaining forces by suction air. Compressed air may be made ready or provided, for example, for quickly releasing the retaining forces produced.

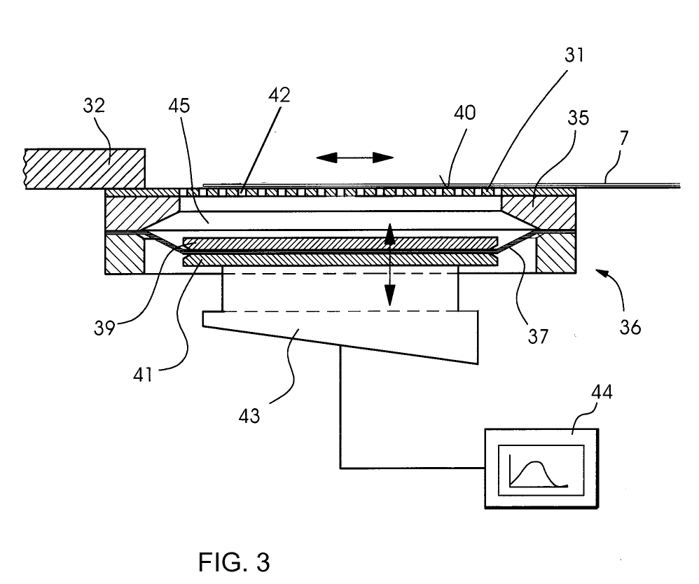

FIG. 3 illustrates a pneumatic pressure generator 36 that is disposed directly on the pulling bar 31. The pressure generator 36 shown in FIG. 3 is basically made up of a diaphragm or membrane 37, which forms a boundary wall of a housing 35, for example of the pulling bar 31. The membrane 37 has reinforcing elements in the shape of two plates 39 and 41. One of the plates 39 is disposed opposite a top side 40 of the pulling bar 31. The top side 40 is formed with openings 42 which come into operating contact with an underside of the sheets 7 to be aligned.

The other plate 41, which is disposed in parallel with the plate 39, is operatively connected with an actuator 43 such as an hydraulic cylinder, piezoelectric actuator or, preferably, a moving-coil or plunger-type actuator. The plate 41, the membrane 37, the pulling bar housing 31, and the top side 40 of the pulling bar form an operating space 45. The moving-coil or plunger-type actuator 43 is controlled by a control unit 44 of the sheet-processing machine 1 in accordance with the cycle of the machine, according to or following a characteristic line or closed-loop control circuit.

When the moving-coil or plunger-type actuator 43 is actuated, for example to produce a retaining force between the pulling bar 31 and a sheet 7 that is to be aligned in a lateral direction, the moving-coil or plunger-type actuator 43 is displaced in a downward direction and entrains the plates 39 and 41 and the membrane 37, which is disposed between the plates 39 and 41. As a result, the volume of the operating space or working chamber 45 is increased abruptly, creating negative pressure in the operating space or working chamber 45. The negative pressure produced in this manner acts on the lower side of the sheet 7 to be aligned and holds the sheet fast. When the actuator 43 is displaced in the opposite, i.e. upward direction, the volume of the operating space or working chamber 45 is decreased and an increased pressure results, which acts as a pushing force on the sheet. In this way, the retaining force in effect between the upper side 40 of the pulling bar and the lower side of the sheet 7 can be released abruptly.

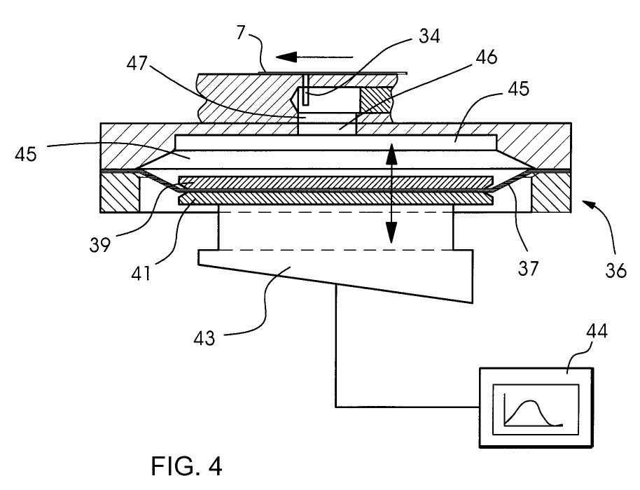

FIG. 4 illustrates a further possible configuration of the pneumatic pressure generator 36. The operating space or working chamber 45 directly communicates with an opening 47 of the groove or slot 34 through an opening 46.

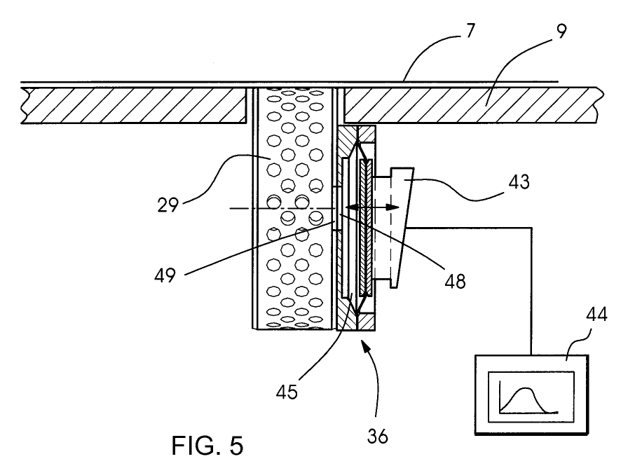

FIG. 5 shows the pneumatic pressure generator 36 laterally flanged to the advancing roller 29. In this regard, the operating space or working chamber 45 directly communicates with openings 49 through a connecting opening 48. The openings 49, which are distributed over the circumference of the advancing roller 29, apply a retaining force on the respective sheet 7.

1. A sheet-processing machine, comprising:
a consumer; and
a device for generating at least one of pneumatic pressure or suction pulses for said consumer;
said device including a pneumatic pressure generator having a variable-volume operating space; and
said consumer disposed directly at said variable-volume operating space of said pneumatic pressure generator.

2. The sheet-processing machine according to claim 1, wherein said operating space has a movable boundary wall.

3. The sheet-processing machine according to claim 2, wherein said boundary wall is a membrane.

4. The sheet-processing machine according to claim 2, which further comprises an actuator for displacing said membrane.

5. The sheet-processing machine according to claim 4, wherein said actuator is a moving-coil actuator.

6. The sheet-processing machine according to claim 5, which further comprises a control unit for controlling said actuator in accordance with a processing cycle of the sheet-processing machine, following a characteristic line or a closed-loop control circuit.

7. The sheet-processing machine according to claim 1, wherein said consumer is a pulling bar in an alignment region of a sheet feeder.

8. The sheet-processing machine according to claim 1, wherein said consumer is a groove disposed transversely to a direction of sheet travel in an alignment region of a sheet feeder.

9. The sheet-processing machine according to claim 1, wherein said consumer is an advancing member disposed in an alignment region of a sheet feeder.

10. The sheet-processing machine according to claim 1, wherein the sheet-processing machine is a rotary printing press.
